(19) United States
(12) Patent Application Publication
(10) Pub. No.: US 2025/0202516 A1
(43) Pub. Date: Jun. 19, 2025

(54) COMMUNICATION CIRCUITRY WITH INDUCTIVE CROSS-COUPLING REDUCTION

(71) Applicant: Qorvo US, Inc., Greensboro, NC (US)

(72) Inventor: Yazid Yusuf, Orlando, FL (US)

(21) Appl. No.: 18/929,995

(22) Filed: Oct. 29, 2024

Related U.S. Application Data
(60) Provisional application No. 63/611,939, filed on Dec. 19, 2023.

(51) Int. Cl. H04B 1/10; H04B 1/00; H04B 1/04

(52) U.S. Cl. CPC H04B 1/1036; H04B 1/0078; H04B 1/0475

(57) ABSTRACT

Communication circuitry is disclosed having radio frequency circuitry with an input terminal and an output terminal, wherein an input inductor is coupled between the input terminal and a common node. An output inductor is coupled between the output terminal and the common node, wherein the input inductor and the output inductor are configured to have a negative mutual inductance. A compensation inductor is coupled between the common node and a fixed voltage node, wherein the compensation inductor is configured to have a self-inductance that substantially cancels the negative mutual inductance between the input inductor and the output inductor.

### RELATED APPLICATIONS

This application claims the benefit of provisional patent application Ser. No. 63/611,939, filed Dec. 19, 2023, the disclosure of which is hereby incorporated herein by reference in its entirety.

### FIELD OF THE DISCLOSURE

The present disclosure relates to reducing mutual inductance coupling in communications circuitry.

### BACKGROUND

Inductive cross-coupling may occur in various circuitries that include but are not limited to passive filters, acoustic filters, and amplifiers and combinations thereof. For example, inductive couplings across different stages in filter structures result in undesirable degradation in filter rejection. A common approach to avoid such couplings is to confine inductors/coils within shielding structures, which decreases the quality factor of the inductors due to ohmic losses associated with currents on the shields. Another drawback is the increased solution size due to the additional shielding structures. What is needed are circuitries and methods that provide reduction in inductive cross-coupling that provide solutions to such drawbacks.

### SUMMARY

Communication circuitry is disclosed having radio frequency circuitry with an input terminal and an output terminal, wherein an input inductor is coupled between the input terminal and a common node. An output inductor is coupled between the output terminal and the common node, wherein the input inductor and the output inductor are configured to have a negative mutual inductance. A compensation inductor is coupled between the common node and a fixed voltage node, which is commonly ground (GND), wherein the compensation inductor is configured to have a positive self-inductance that substantially cancels the negative mutual inductance between the input inductor and the output inductor.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a schematic diagram of related-art acoustic filter circuitry that suffers from the mutual coupling (M) of cross-coupled inductors.

FIG. 2 is a graph of rejection versus frequency for different levels of mutual coupling M for the related-art acoustic filter.

FIG. 3 is a schematic diagram of mutual inductance decoupling circuitry that in accordance with the present disclosure is configured to decouple input and output inductors by way of negative mutual coupling (−|M|) and a corresponding compensation inductor.

FIG. 4 is a schematic diagram of a T-model of the mutual inductance decoupling circuitry illustrating the inductive decoupling provided by the negative mutual coupling and a positive mutual coupling provided by the compensation inductor.

FIG. 5 is a schematic diagram of a resultant model illustrating substantially complete inductive decoupling provided by the circuitry structure of FIG. 3.

FIG. 6 is a schematic diagram of the circuitry structure model that is labeled for mathematical analysis for determining an inductance value for the compensation inductor.

FIG. 7 is a schematic diagram of exemplary acoustic filter circuitry including the mutual inductance decoupling circuitry of FIG. 3 that is configured to decouple the input and output inductors by way of negative mutual coupling (−|M|) and a corresponding compensation inductor.

FIG. 8 is a graph of rejection versus frequency illustrating that the exemplary acoustic filter circuitry that includes the circuitry structure of FIG. 3 substantially completely decouples the input and output inductors to maximize desired filter rejection.

FIG. 9 is a schematic diagram of exemplary communications circuitry that includes the circuitry structure of FIG. 3 and is configured to decouple the input and output inductors by way of negative mutual coupling (−|M|) and a corresponding compensation inductor.

FIG. 10 is a diagram showing how the disclosed communications circuitry including the circuitry structure may interact with user elements such as wireless communication devices.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

Capacitive and inductive parasitics in filter implementations are known to adversely affect filter rejection especially when filter rejections more than 50 dB are needed. Among possible inductive parasitics, direct magnetic coupling between matching inductors located at a filter's input and output terminals is most impactful.

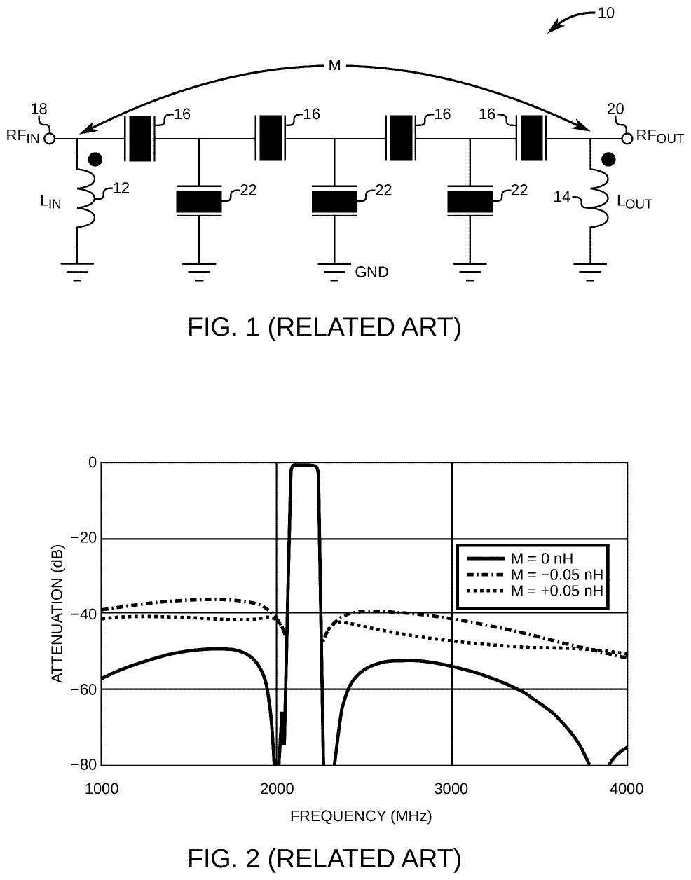

FIG. 1 is a schematic diagram of related-art acoustic filter circuitry 10 that suffers from the magnetic mutual coupling (M) between an input inductor 12, labeled L_{IN}, and an output inductor 14, labeled L_{OUT}. Due to the mutual coupling M the input inductor 12 and the output inductor 14 are referred to as being magnetically cross-coupled. In this related-art example, series acoustic resonators 16 are coupled between a radio frequency (RF) input terminal 18, labeled RF_{IN}, and an RF output terminal 20, labeled RF_{OUT}. Parallel acoustic resonators 22 are coupled at nodes between corresponding ones of the series acoustic resonators 16 and a fixed voltage node GND. In this case, the fixed voltage node GND is ground. The input inductor 12 is coupled between the RF input terminal 18 and the fixed voltage node ground GND. The output inductor 14 is coupled between the RF output terminal 20 and the fixed voltage node GND.

FIG. 2 is a filter response graph for the related-art acoustic filter circuitry 10 that shows the effect of mutual inductance M on filter rejection, where filter response is shown without mutual coupling wherein M=0 compared with cases wherein M=±0.05 nH. These unmitigated amounts of mutual coupling M result in a large degradation in filter rejection.

With the continued trend towards highly integrated modules, filter dies are increasingly getting smaller and matching components constitute larger portions of available module real estate. Typically, shielding structures are used to reduce undesired coupling between inductors. However, these structures increase implementation size and result in decreased inductor quality factors (Qs) due to associated currents and ohmic loss.

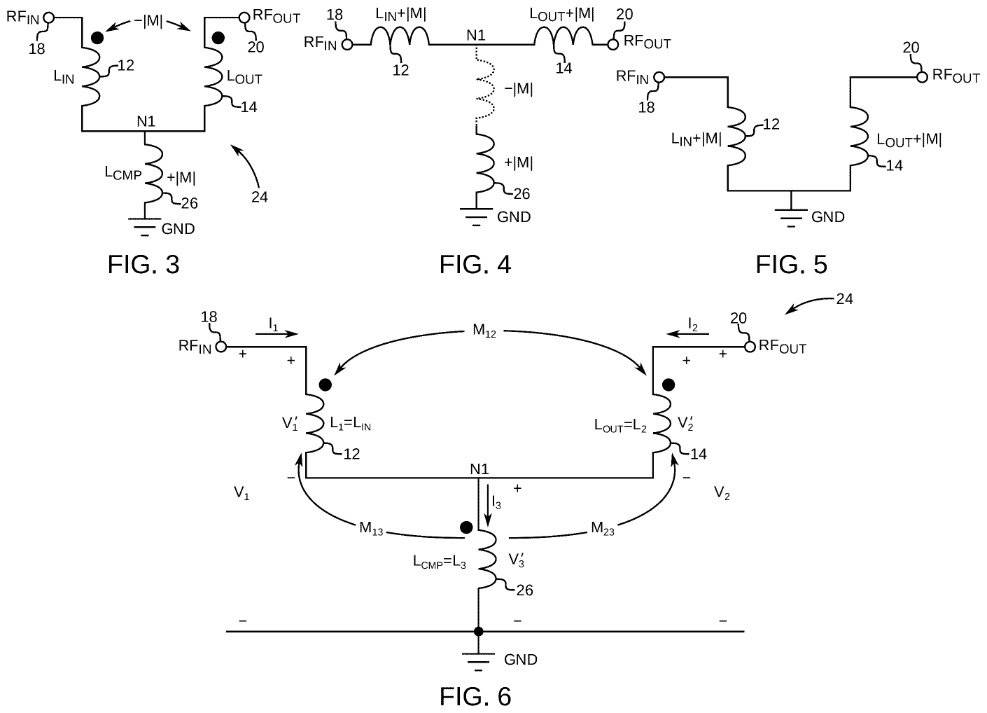

FIG. 3 is a schematic diagram of mutual inductance decoupling circuitry 24 that in accordance with the present disclosure is configured to magnetically decouple input inductor 12 from the output inductor 14. The magnetically decoupling is accomplished by way of negative mutual coupling (−|M|) and a corresponding compensation inductor 26 that is labeled L_{CMP}. In contrast to the related-art acoustic filter circuitry 10 of FIG. 1, the input inductor 12 and the output inductor 14 are not coupled directly to the fixed voltage node GND. Instead, in this case, the input inductor 12 is coupled between the RF input terminal 18 and a first common node N1 that is different from the fixed voltage node GND. The output inductor 14 is coupled between the first common node N1 and the RF output terminal 20. The compensation inductor 26 is coupled between the first common node N1 and the fixed voltage node GND. The inductances of the input inductor 12, the output inductor 14, are typically between 0.5 nH and 20 nH depending on application and frequency. The compensation inductor 26 has an inductance that is typically between 1 percent and 10 percent of either of the inductance of input inductor 12 or the inductance of the output inductor 14. The input inductor 12, the output inductor 14, and the compensation inductor 26 are typically fabricated from traces within one or more metal layers in a multi-chip module (not shown).

FIG. 4 is a schematic diagram of a T-model of the mutual inductance decoupling circuitry 24 illustrating the inductive decoupling provided by the negative mutual coupling and a positive mutual coupling provided by the compensation inductor 26. FIG. 5 is a schematic diagram of a resultant model illustrating substantially complete inductive decoupling provided by the mutual inductance decoupling circuitry 24 of FIG. 3. Note that in FIG. 5 the initial mutual inductance between input inductor 12 and the output inductor 14 appears in the form of additional self-inductance |M| to the input inductor Lin and output inductor Lout. The self-inductance |M| does not reduce the substantial cancellation of the mutual inductance |M| between the input inductor 12 and the output inductor 14.

FIG. 6 is a schematic diagram of the mutual inductance decoupling circuitry 24 that is labeled for mathematical analysis for determining an inductance value for the compensation inductor 26. The analysis accounts for possible mutual coupling between the compensating inductor and the input and output inductors. In equations that follow, the input inductor 12 is relabeled L₁, the output inductor 14 is relabeled L₂, and the compensation inductor 26 is relabeled L₃. A first current I₁ flows through the L₁ inductor 12, a second current I₂ flows through the L₂ inductor 14, and a third current Is flows through the L₃ inductor 26. The third current I₃ is the sum of the first current I₁ and the second current I₂. A first inductive voltage V′₁ is developed across the L₁ inductor 12, a second inductive voltage V′₂ is developed across the L₂ inductor 14, and a third inductive voltage V′₃ is developed across the L₃ inductor 26. An input voltage V₁ is the sum of the first inductive voltage V′₁ and the third inductive voltage V′₃, while an output voltage V₂ is the sum of the second inductive voltage V′₂ and the third inductive voltage V′₃. A first mutual inductance M₁₂ is between the L₁ inductor 12 and the L₂ inductor 14. A second mutual inductance M₂₃ is between the L₂ inductor 14 and the L₃ inductor 26. A third mutual inductance M₁₃ is between the L₁ inductor 12 and the L₃ inductor 26.

A general set of mathematical relationships for the three mutual inductances between coupled inductors L₁, L₂, and L₃ are described using the following equations:

$$[ \begin{matrix}{V}_{1}^{′} \\ {V}_{2}^{′} \\ {V}_{3}^{′}\end{matrix} ] = j ω [ \begin{matrix}{L}_{1} & {M}_{12} & {M}_{13} \\ {M}_{12} & {L}_{2} & {M}_{23} \\ {M}_{13} & {M}_{23} & {L}_{3}\end{matrix} ] [ \begin{matrix}{I}_{1} \\ {I}_{2} \\ {I}_{3}\end{matrix} ]$$

The mutual inductances Mᵢⱼ are related to coupling coefficients kᵢⱼ using:

$${k}_{ij} = \frac{{M}_{ij}}{\sqrt{{L}_{i} {L}_{j}}}$$

The coupling coefficients kᵢⱼ are each of substantially similar magnitude and are typically less than 0.1 for applications envisioned for the embodiments of this disclosure.

Kirchoff's voltage and current laws yield the following mathematical relationships for the mutual inductance decoupling circuitry 24 depicted in FIG. 6.

$$\begin{matrix}{V}_{1} = {V}_{1}^{′} {V}_{3}^{′} \\ {V}_{1} = {V}_{2}^{′} {V}_{3}^{′} \\ {I}_{3} = {I}_{1} + {I}_{2}\end{matrix}$$

Combining the equations above yields the following system of equations for the mutual inductance decoupling circuitry 24 depicted in FIG. 6.

$$[ \begin{matrix}{V}_{1} \\ {V}_{2}\end{matrix} ] = j ω [ \begin{matrix}{L}_{1} + 2 {M}_{13} + L - 3 & {M}_{12} + {M}_{13} + {M}_{23} + {L}_{3} \\ {M}_{12} + {M}_{13} + {M}_{23} + {L}_{3} & {L}_{2} + 2 {M}_{23} + {L}_{3}\end{matrix} ] [ \begin{matrix}{I}_{1} \\ {I}_{2}\end{matrix} ]$$

To magnetically decouple the L₁ inductor and the L₂ inductor, the following relationship is employed:

$${M}_{12} + {M}_{13} + {M}_{23} + {L}_{3} = 0$$

which, in turn yields:

$${L}_{3} = - {M}_{12} - {M}_{13} - {M}_{23}$$

As such, if M₁₃=M₂₃=0, then L₃=−M₁₂.
In terms of coupling coefficients kᵢⱼ:

$${L}_{3} = - {M}_{12} - {M}_{13} - {M}_{23}$$

becomes,

$${L}_{3} = - {M}_{12} - {k}_{13} \sqrt{{L}_{1}} \sqrt{{L}_{3}} - {k}_{23} \sqrt{{L}_{2}} \sqrt{{L}_{3}}$$

Assuming M₁₂ to be negative: M₁₂=−|M₁₂|
Define: x=\sqrt{L₃} yields:

$${x}^{2} + ( {k}_{13} \sqrt{{L}_{1}} + {k}_{23} \sqrt{{L}_{2}} ) x - \vert {M}_{12} \vert = 0$$

### Solve for x:

$$x = - \frac{{k}_{13} \sqrt{{L}_{1}} + {k}_{23} \sqrt{{L}_{2}}}{2} + \sqrt{{[ \frac{{k}_{13} \sqrt{{L}_{1}} + {k}_{23} \sqrt{{L}_{2}}}{2} ]}^{2} + \vert {M}_{12} \vert}$$

therefore:

$${L}_{3} = {[ - \frac{{k}_{13} \sqrt{{L}_{1}} + {k}_{23} \sqrt{{L}_{2}}}{2} + \sqrt{{[ \frac{{k}_{13} \sqrt{{L}_{1}} + {k}_{23} \sqrt{{L}_{2}}}{2} ]}^{2} + \vert {M}_{12} \vert} ]}^{2}$$

This equation provides a calculated value for the inductance needed for the compensation inductor 26 (FIGS. 3, 4, and 6) to magnetically decouple the input inductor 12 from the output inductor 14. This equation also proves that there is always a corresponding compensating inductance value provided that the first mutual inductance M₁₂ is made negative. The first mutual inductance M₁₂ can be ensured by appropriate relative winding directions between the input inductor 12 and the output inductor 14.

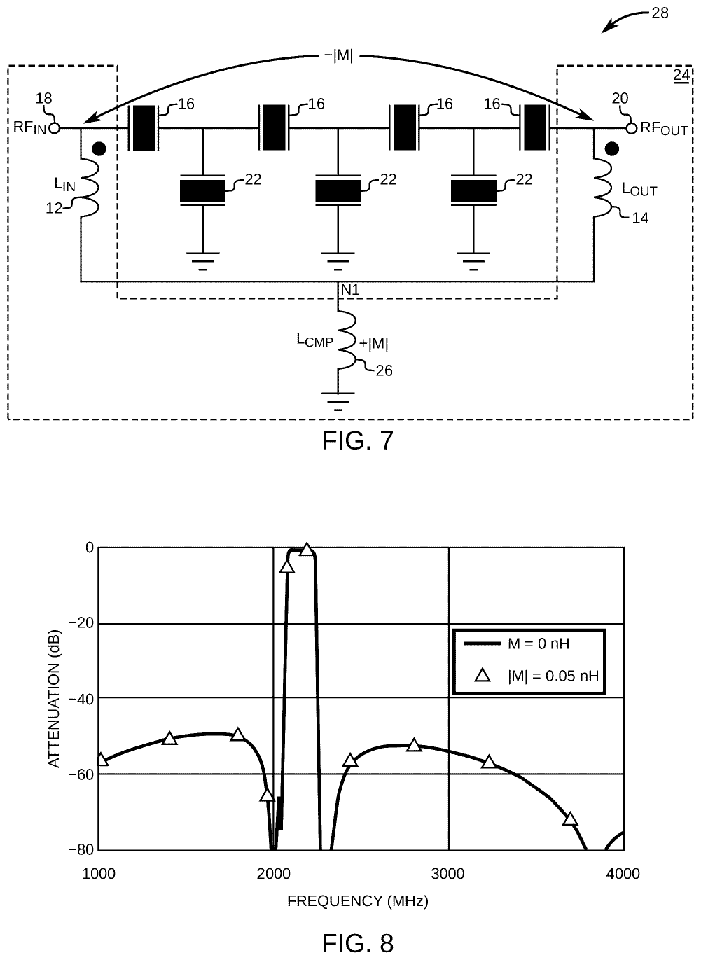

FIG. 7 is a schematic diagram of exemplary acoustic filter circuitry 28 that employs the mutual inductance decoupling circuitry 24. Negative mutual coupling (−|M|) combined with the L₃ inductance value calculated in the foregoing equation for the compensation inductor 26 decouples the input inductor 12 and the output inductor 14.

FIG. 8 is a graph of rejection versus frequency illustrating that the exemplary acoustic filter circuitry 28 that includes the mutual inductance decoupling circuitry 24 substantially completely magnetically decouples the input inductor 12 and the output inductor 14 to maximize desired filter rejection. Notice that a mutual inductance |M|=0.05 nH is practically completely canceled as shown by the triangular markers of |M|=0.05 nH falling on top of the filter response curve of M=0 nH.

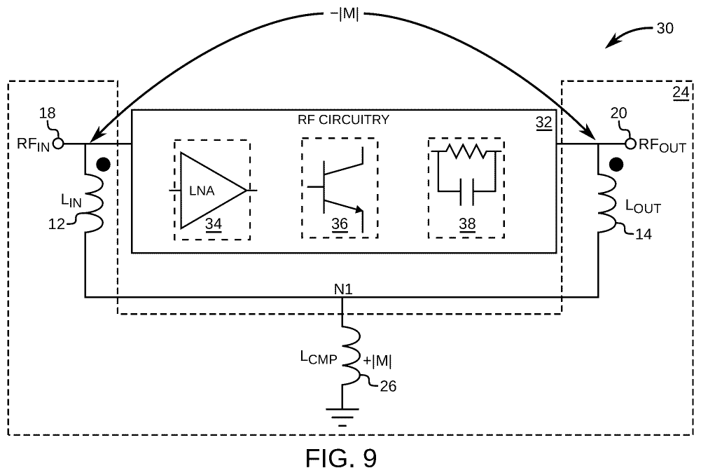

FIG. 9 is a schematic diagram of exemplary communications circuitry 30 that includes the mutual inductance decoupling circuitry 24 depicted in FIGS. 3, 4, and 6. The communications circuitry 30 is configured with the mutual inductance decoupling circuitry 24 to decouple the input inductor 12 and output inductor 14 by way of negative mutual coupling (−|M|) and the corresponding compensation inductor 26. The magnetic decoupling improves the noise figure and other performance metrics of RF circuitry 32. Examples of the RF circuitry 32 include but are not limited to low-noise amplifiers (LNAs) 34, power amplifier circuits 36, and filter circuits 38. The filter circuit 38 may include passive elements such as resistors, capacitors, inductors, and acoustic resonators such as serial resonators 16 and parallel resonators 22 as depicted in FIG. 1 and FIG. 7. Moreover, as depicted in FIG. 9, the RF circuitry 32 may be made up of any one or combinations of the LNA 34, the power amplifier circuits 36, and the filter circuits 38.

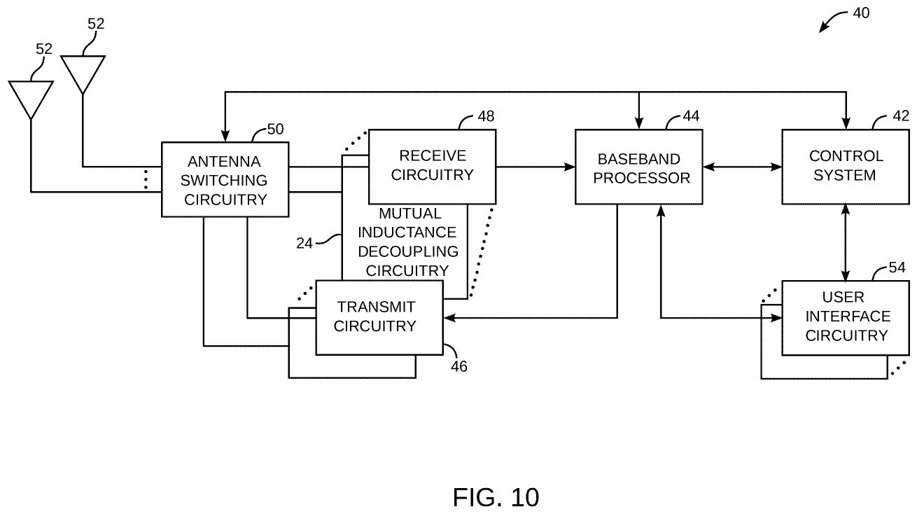

With reference to FIG. 10, the concepts described above may be implemented in various types of wireless communication devices or user elements 40, such as mobile terminals, smart watches, tablets, computers, navigation devices, access points, and the like that support wireless communications, such as cellular, wireless local area network (WLAN), Bluetooth, and near-field communications. The user elements 40 will generally include a control system 42, a baseband processor 44, transmit circuitry 46, receive circuitry 48, antenna switching circuitry 50, multiple antennas 52, and user interface circuitry 54. The mutual inductance decoupling circuitry 24 may be employed by the transmit circuitry 46 and/or the receive circuitry 48 to realize communication circuitry 30 such as that depicted in the exemplary embodiment of FIG. 9.

The receive circuitry 48 receives radio frequency signals via the antennas 52 and through the antenna switching circuitry 50 from one or more basestations. A low-noise amplifier and a filter (not shown) cooperate to amplify and remove broadband interference from the received signal for processing. Downconversion and digitization circuitry (not shown) then downconverts the filtered, received signal to an intermediate or baseband frequency signal, which is then digitized into one or more digital streams.

The baseband processor 44 processes the digitized received signal to extract the information or data bits conveyed in the received signal. This processing typically comprises demodulation, decoding, and error correction operations. The baseband processor 44 is generally implemented in one or more digital signal processors (DSPs) and application-specific integrated circuits (ASICs).

For transmission, the baseband processor 44 receives digitized data, which may represent voice, data, or control information, from the control system 42, which it encodes for transmission. The encoded data are output to the transmit circuitry 46, where they are used by a modulator (not shown) to modulate a carrier signal that is at a desired transmit frequency or frequencies. A power amplifier (not shown) amplifies the modulated carrier signal to a level appropriate for transmission and delivers the modulated carrier signal to the antennas 52 through the antenna switching circuitry 50. The antennas 52 and the replicated transmit circuitry 46 and receive circuitry 48 may provide spatial diversity. Modulation and processing details will be understood by those skilled in the art.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. Communication circuitry comprising:
radio frequency (RF) circuitry having an input terminal and an output terminal;
an input inductor coupled between the input terminal and a common node;
an output inductor coupled between the output terminal and the common node, wherein the input inductor and the output inductor are configured to have a negative mutual inductance; and
a compensation inductor coupled between the common node and a fixed voltage node, wherein the compensation inductor is configured to have a self-inductance that substantially cancels the negative mutual inductance between the input inductor and the output inductor.

2. The communication circuitry of claim 1 wherein the fixed voltage node is ground.

3. The communication circuitry of claim 1 wherein the RF circuitry comprises inductors, capacitors, and resistors configured as a filter.

4. The communication circuitry of claim 1 wherein the RF circuitry comprises acoustic resonators configured as an acoustic filter.

5. The communication circuitry of claim 1 wherein the RF circuitry comprises a low-noise amplifier.

6. The communication circuitry of claim 1 wherein the RF circuitry comprises a power amplifier.

7. The communications circuitry of claim 1 wherein the inductance of the compensation inductor is sized based upon magnetic coupling coefficients between the input inductor, the output inductor, and the compensation inductor.

8. The communications circuitry of claim 1 wherein the mutual inductance between the input inductor and the output inductor is substantially zero.

9. A wireless communication device comprising:
a baseband processor configured to digitize and process radio frequency (RF) signals;
communication circuitry configured to process analog versions of the RF signals between the baseband processor and the communication circuitry, wherein the communication circuitry comprises;
RF circuitry having an input terminal and an output terminal; and
mutual inductance decoupling circuitry comprising:
an input inductor coupled between the input terminal and a common node;
an output inductor coupled between the output terminal and the common node, wherein the input inductor and the output inductor are configured to have a negative mutual inductance; and
a compensation inductor coupled between the common node and a fixed voltage node, wherein the compensation inductor is configured to have a self-inductance that substantially cancels the negative mutual inductance between the input inductor and the output inductor.

10. The wireless communication device of claim 9 wherein the RF circuitry comprises receive circuitry.

11. The wireless communication device of claim 9 wherein the RF circuitry comprises transmit circuitry.

12. The wireless communication device of claim 9 wherein the RF circuitry comprises inductors, capacitors, and resistors configured as a filter.

13. The wireless communication device of claim 9 wherein the RF circuitry comprises acoustic resonators configured as an acoustic filter.

14. The wireless communication device of claim 9 wherein the fixed voltage node is ground.

15. The wireless communication device of claim 9 wherein the RF circuitry comprises a low noise amplifier.

16. The wireless communication device of claim 9 wherein the RF circuitry comprises a power amplifier.

17. The wireless communication device of claim 9 wherein the inductance of the compensation inductor is sized based upon magnetic coupling coefficients between the input inductor, the output inductor, and the compensation inductor.

18. The wireless communication device of claim 9 wherein the mutual inductance between the input inductor and the output inductor is substantially zero.

19. A method of designing communication circuitry having radio frequency (RF) circuitry coupled between an input terminal and an output terminal with an input inductor coupled between the input terminal and a common node, an output inductor coupled between the output terminal and the common node, and a compensation inductor coupled between the common node and a fixed voltage node, the method comprising:
configuring the input inductor and the output inductor to have a negative mutual inductance, and
configuring the compensation inductor is configured to have a self-inductance that substantially cancels the negative mutual inductance between the input inductor and the output inductor.

20. The method of designing communication circuitry of claim 19 further comprising sizing the inductance of the compensation inductor based upon magnetic coupling coefficients between the input inductor, the output inductor, and the compensation inductor.
